(19) United States
(12) Patent Application Publication
(10) Pub. No.: US 2026/0133291 A1
(43) Pub. Date: May 14, 2026

(54) LIDAR SYSTEM AND VEHICLE

(71) Applicant: HON HAI PRECISION INDUSTRY CO., LTD., New Taipei (TW)

(72) Inventor: MIN-CHI HSU, New Taipei (TW)

(21) Appl. No.: 19/364,039

(22) Filed: Oct. 21, 2025

Related U.S. Application Data
(60) Provisional application No. 63/720,261, filed on Nov. 14, 2024.

(51) Int. Cl. G01S 7/481; G01S 13/88

(52) U.S. Cl. CPC G01S 7/4814; G01S 7/4813; G01S 7/4817; G01S 13/88

(57) ABSTRACT

Embodiments of the present disclosure relates to a LiDAR system and a vehicle. The LiDAR system includes a housing having an accommodating space and a transmitting module in the accommodating space. The housing includes a first side plate, and a light-transmitting top plate connected to and perpendicular to the first side plate. The transmitting module includes a light source module, a first light guiding module, and a first scanning module. The light source module, attached to the first side plate, vertically emits detection light. The detection light is received and guided by the first light guiding module to the first scanning module, which then projected to a target through the top plate.

### FIELD

The subject matter herein generally relates to the field of light detection and ranging (LiDAR) technology, specifically to a LiDAR system and a vehicle using the LiDAR system.

### BACKGROUND

With advancements in technology, autonomous driving functionalities in vehicles have gained increasing adoption. LiDAR systems, owing to high precision, adaptability, and superior environmental perception capabilities, have emerged as a critical hardware component in autonomous driving and advanced driver assistance systems. However, existing LiDAR systems often suffer from excessive size, which impacts the overall dimensions of vehicles employing such systems, consequently reducing the lightweight characteristics of those vehicles.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic structural diagram of a LiDAR according to an embodiment of the present disclosure.

FIG. 2 is a front view of the LiDAR in FIG. 1, after removing a fourth side plate.

FIG. 3 is a schematic structural diagram illustrating a collimating module of the LiDAR in FIG. 1, the collimating module collimating detection light.

FIG. 4 is a structural schematic diagram of a vehicle according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

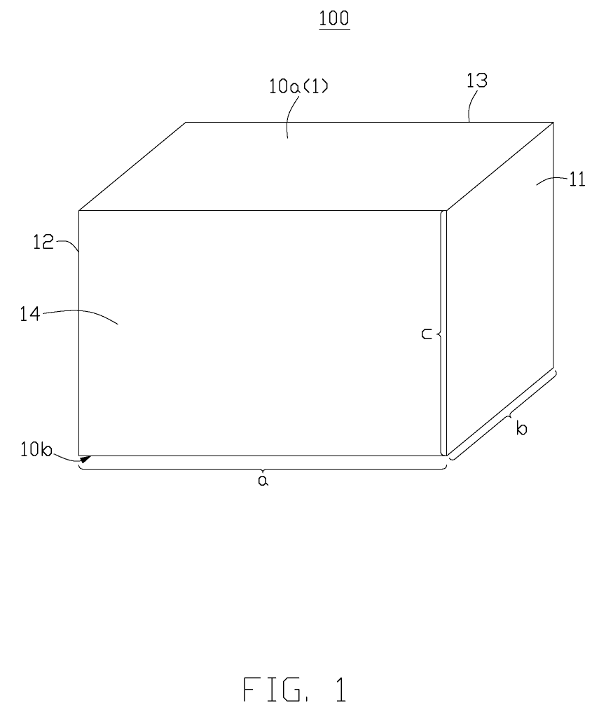

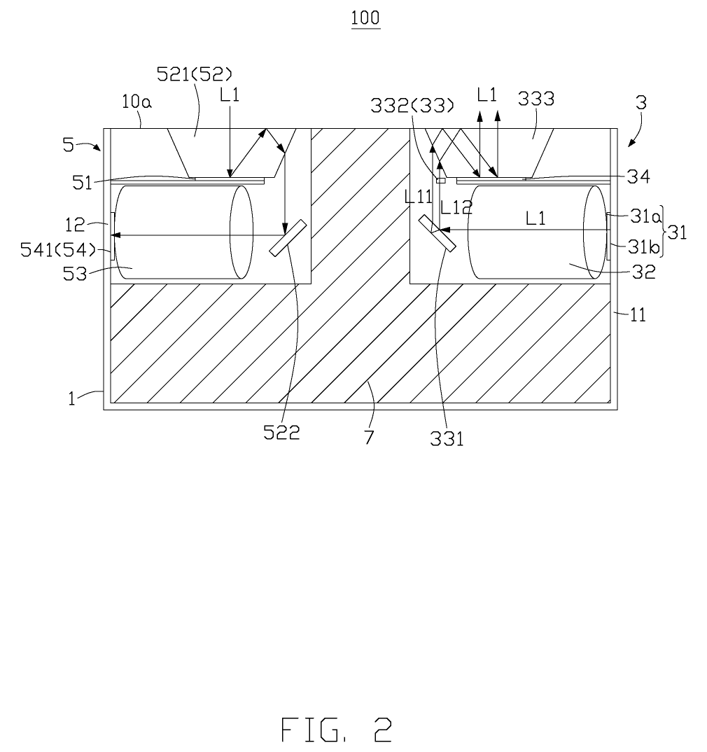

As shown in FIG. 1 and FIG. 2, a LiDAR system 100 according to embodiments of the present disclosure includes a housing 1, a transmitting module 3, a receiving module 5, and an electronic control module 7.

The housing 1 has a substantially hollow rectangular parallelepiped shape. The housing 1 includes an accommodating space 1a. The accommodating space 1a is enclosed by a plurality of side plates.

The plurality of side plates includes a top plate 10a, a bottom plate 10b opposite to the top plate 10a, a first side plate 11, a second side plate 12, a third side plate 13, and a fourth side plate 14. The first side plate 11, the third side plate 13, the second side plate 12, and the fourth side plate 14 are sequentially connected. The first side plate 11 and the second side plate 12 are opposite to each other and spaced apart in parallel. The third side plate 13 and the fourth side plate 14 are opposite to each other and spaced apart in parallel. The first side plate 11, the second side plate 12, the third side plate 13, the fourth side plate 14, the top plate 10a, and the bottom plate 10b enclose and form the accommodating space 1a.

The transmitting module 3 is in the accommodating space 1a of the housing 1 and attached to the first side plate 11. The transmitting module 3 is configured to emit detection light L1. In some embodiments, the transmitting module 3 is attached to an inner surface of the first side plate 11.

The receiving module 5 is in the accommodating space 1a of the housing 1 and attached to the second side plate 12. The receiving module 5 is configured to receive the detection light L1 reflected from a target to be measured, and obtain position information of the target based on the detection light L1. In some embodiments, the receiving module 5 is attached to an inner surface of the second side plate 12.

The electronic control module 7 is in the accommodating space 1a of the housing 1 and electrically connected to the transmitting module 3 and the receiving module 5. The electronic control module 7 is configured to control the transmitting module 3 to emit the detection light L1, and to receive the position information of the target transmitted from the receiving module 5.

In some embodiments, the length ‘a’ of the housing 1 ranges from 105mm to 115mm, the width ‘b’ of the housing 1 ranges from 20mm to 30mm, and the height ‘c’ of the housing 1 ranges from 55mm to 65mm.

The length ‘a’ of the housing 1 can be any value among 105mm, 108mm, 110mm, 112mm, or 115mm. The width ‘b’ of the housing 1 can be any value among 20mm, 22mm, 25mm, 28mm, or 30mm. The height ‘c’ of the housing 1 can be any value among 55mm, 57mm, 60mm, 63mm, or 65mm.

Setting the dimensions of the housing 1 within the above ranges helps to reduce the volume of the housing 1 while satisfying the transceiver performance of the LiDAR system 100.

The top plate 10a is perpendicular to the first side plate 11 and is overall configured to transmit light. The material of the top plate 10a of the housing 1 is a light-transmitting material. The material of the top plate 10a of the housing 1 can be glass or plastic, such as polymethyl methacrylate (PMMA), polycarbonate (PC), or polyethylene terephthalate (PET).

The material of the first side plate 11 and the second side plate 12 can be copper, iron, aluminum, aluminum alloy, or titanium alloy. For example, when the material of the first side plate 11 and the second side plate 12 is aluminum alloy, the weight of the LiDAR system 100 can be further reduced, which is advantageous to further improve the lightweight level of the LiDAR system 100.

The transmitting module 3 includes a light source module 31, a collimating module 32, a first light guiding module 33, and a first scanning module 34. The light source module 31 is attached to the first side plate 11 and configured to emit detection light L1. In some embodiments, the light source module 31 is attached to an inner surface of the first side plate 11.

The detection light L1 includes a first sub-detection light L11 having a first polarization state and a second sub-detection light L12 having a second polarization state. The first polarization state is perpendicular to the second polarization state.

In some embodiments, the first sub-detection light L11 is p-polarized light, i.e., a linear polarization state with a polarization direction parallel to the incident plane. The second sub-detection light L12 is s-polarized light, i.e., a linear polarization state with a polarization direction perpendicular to the incident plane.

In other embodiments, the first polarization state and the second polarization state can be left-handed circular polarization states or right-handed circular polarization states.

The light source module 31 has an emitting end face 31a and an attaching surface 31b. The emitting end face 31a is spaced apart from and parallel to the attaching surface 31b. The attaching surface 31b is attached to the inner surface of the first side plate 11. The emitting end face 31a is configured to vertically emit detection light L1 in a direction away from the first side plate 11, that is, the detection light L1 is perpendicular to the inner surface of the first side plate 11.

In some embodiments, the light source module 31 is a vertical-cavity surface-emitting laser (VCSEL). When the light source module 31 is a VCSEL laser, compared to using an edge-emitting laser (EEL), it is advantageous to improve the light intensity and light density of the detection light L1, and to further reduce the volume of the LiDAR system 100.

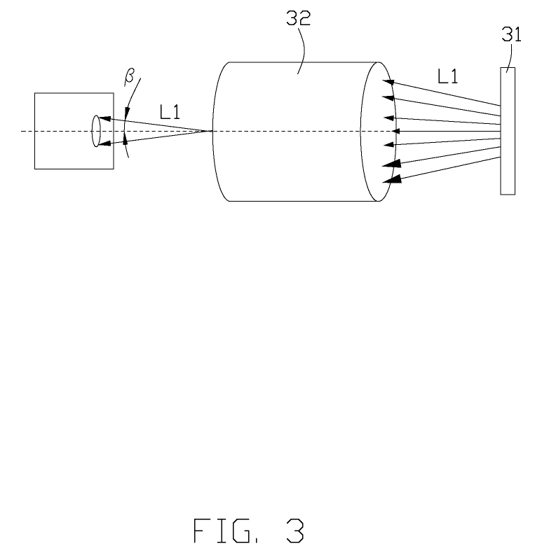

Please refer to FIG. 1, FIG. 2, and FIG. 3. The collimating module 32 is at a light exit side of the light source module 31 and between the light source module 31 and the first light guiding module 33. The collimating module 32 is configured to receive and converge a divergence angle of the detection light L1 emitted from the light source module 31.

In some embodiments, the collimating module 32 includes a plurality of refractive lenses (not shown), where the dioptric powers of the plurality of lenses are the same or different to converge the incident detection light L1.

In some embodiments, the collimating module 32 is configured to converge the divergence angle β of the detection light L1, such that the range of the divergence angle β of the detection light L1 is 10° to 20°.

In some embodiments, the divergence angle β of the detection light L1 can be any value among 10°, 11°, 13°, 15°, 17°, 19°, or 20°. When the detection light L1 is incident on the collimating module 32, the collimating module 32 converges the divergence angle β of the detection light L1, so that the light spot of the detection light L1 emitted from the collimating module 32 is approximately reduced to an elliptical shape, which is advantageous for the first light guiding module 33 to receive the detection light L1, to reduce the optical energy loss of the detection light L1, and further to improve the space utilization within the housing 1 while satisfying the transceiver performance of the LiDAR system 100.

The first light guiding module 33 is at a light exit side of the collimating module 32 and configured to receive and guide the detection light L1 emitted from the collimating module 32. The first light guiding module 33 includes a polarization beam splitter 331, a phase delay element 332, and a first light-transmitting element 333. The polarization beam splitter 331 is at the light exit side of the collimating module 32 and configured to transmit the first sub-detection light L11 and reflect the second sub-detection light L12. That is, the polarization beam splitter 331 is configured to transmit p-polarized light and reflect s-polarized light.

The phase delay element 332 is in an optical path of the second sub-detection light L12 and configured to receive the second sub-detection light L12 and convert the second sub-detection light L12 into the first sub-detection light L11 having the first polarization state. That is, the phase delay element 332 is configured to convert s-polarized light into p-polarized light.

In some embodiments, the phase delay element 332 is a half-wave plate. In other embodiments, the phase delay element 332 can be two quarter-wave plates, which is not limited in the present disclosure.

In other embodiments, the first light-transmitting element 333 is a trapezoidal prism, attached to an inner surface of the top plate 10a, and in an optical path of the first sub-detection light L11. The first light-transmitting element 333 is configured to receive the first sub-detection light L11 emitted from the polarization beam splitter 331 and the phase delay element 332, and guide the first sub-detection light L11 to the first scanning module 34.

The first scanning module 34 is configured to receive and project the detection light L1, such that the detection light L1 directed to exit from the top plate 10a to the target to be measured.

In other embodiments, the first scanning module 34 is a micro-electro-mechanical system (MEMS) mirror. Using a MEMS micro-mirror helps to further reduce optical loss and further reduce volume compared to traditional rotating mirrors, thereby improving space utilization of the housing 1 while satisfying the transceiver performance of the LiDAR system 100, and reducing the volume of the LiDAR system 100.

The receiving module 5 includes a second scanning module 51, a second light guiding module 52, a receiver lens 53, and a photoelectric conversion module 54. The second scanning module 51 is between the second light guiding module 52 and the receiver lens 53 and configured to receive and guide the detection light L1 to the second light guiding module 52.

In some embodiments, the second scanning module 51 is a MEMS mirror. Using a MEMS micro-mirror can effectively reduce the optical loss of the returned detection light L1, and further reduce the volume compared to traditional rotating mirrors, thereby improving space utilization of the housing 1 while satisfying the transceiver performance of the LiDAR system 100, and reducing the volume of the LiDAR system 100.

The second light guiding module 52 is at a side of the photoelectric conversion module 54 close to the transmitting module 3 and configured to receive and guide the detection light L1 reflected from the target.

The second light guiding module 52 includes a second light-transmitting element 521 and a reflective element 522.

In some embodiments, the second light-transmitting element 521 is a trapezoidal prism, disposed at a side of the second scanning module 51 close to the top plate 10a. The second light-transmitting element 521 is configured to guide the detection light L1 emitted from the second scanning module 51 to be incident on the reflective element 522. The reflective element 522 is configured to reflect the detection light L1 to the receiver lens 53. The reflective element 522 can be, but is not limited to, a mirror.

The receiver lens 53 is at a light exit side of the second light guiding module 52 and configured to receive and guide the detection light L1 to the photoelectric conversion module 54.

In some embodiments, the receiver lens 53 includes a plurality of refractive lenses (not shown), where the dioptric powers of the plurality of lenses are the same or different to converge the incident detection light L1, thereby enabling the detection light L1 to be incident on the photoelectric conversion module 54.

The photoelectric conversion module 54 is attached to the second side plate 12. The photoelectric conversion module 54 is configured to receive the detection light L1 and obtain position information of the target based on the detection light L1. In some embodiments, the photoelectric conversion module 54 is attached to an inner surface of the second side plate 12.

The photoelectric conversion module 54 includes an avalanche photodiode 541. The avalanche photodiode 541 receives the vertically incident detection light L1 transmitted from the module and converts the optical signal into an electrical signal. By using the avalanche photodiode 541, light in the wavelength range of 900nm to1700nm can be received, which meets the requirement of the receiving system of the LiDAR system 100 to detect light with a wavelength of 1550nm.

In other embodiments, photodiodes 541 can be selected according to the wavelength of the light to be detected, such as silicon photomultipliers and single-photon avalanche devices, which is not limited by the present disclosure.

The electronic control module 7 is partially disposed on a side of the transmitting module 3 and the receiving module 5 away from the top plate 10a, and partially disposed between the transmitting module 3 and the receiving module 5, which helps to further improve space utilization within the housing 1 while satisfying the transceiver performance of the LiDAR system 100.

In some embodiments, the electronic control module 7 includes a power supply (not shown) and a controller (not shown). The power supply is configured to apply voltage to the transmitting module 3 and the receiving module 5, and the controller is configured to control the switching of the transmitting module 3 and the receiving module 5 and calculate the position information of the target based on the electrical signal transmitted from the photoelectric conversion module 54.

In some embodiments, the controller can be any one of a controller including an RS485 interface, a central processing unit (CPU), and a single-chip microcomputer (e.g., an STM32 single-chip microcomputer, a 51 single-chip microcomputer, a TMS single-chip microcomputer, a PIC single-chip microcomputer, or an AVR single-chip microcomputer), which is not limited by the present disclosure.

In the LiDAR system 100, the light source module 31 is attached to the first side plate 11 and vertically emits detection light L1 in the direction away from the first side plate 11, the first light guiding module 33 receives and guides the detection light L1 to be incident on the first scanning module 34, and the first scanning module 34 receives and projects the detection light L1, so that the detection light L1 exits from the top plate 10a to the target to be measured. As a result, in the LiDAR 100, the detection light L1 exits from the top plate 10a, which is perpendicular to the first side plate 11, compared to arranging the optical elements of the transmitting module on the same optical axis, this configuration is beneficial for improving the space utilization of the housing 1 while satisfying the transceiver performance of the LiDAR system 100, thereby helping to reduce the volume of the LiDAR system 100.

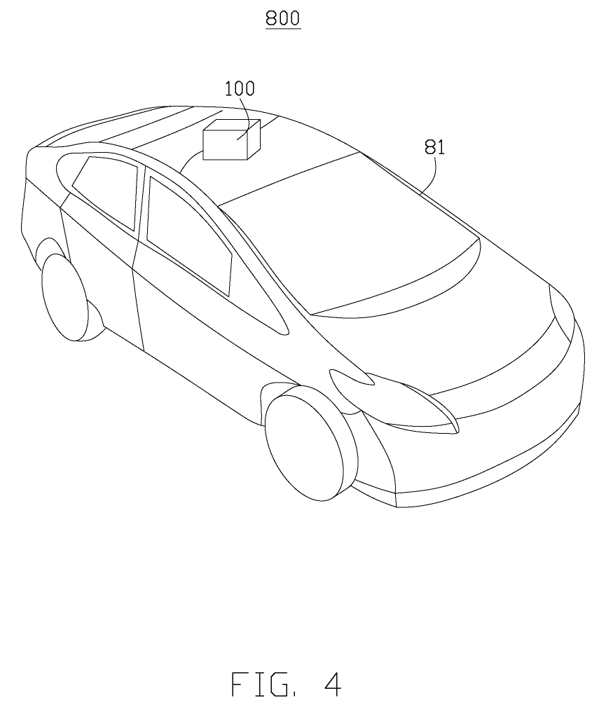

As shown in FIG. 2 and FIG. 4, a vehicle 800 according to embodiments of the present disclosure includes a body 81 and the LiDAR system 100. The LiDAR system 100 is mounted on the body 81 and configured to emit detection light L1 to scan a target to be measured, thereby obtaining position information of the target.

The vehicle 800 can be any one of an electric vehicle, a gasoline vehicle, a diesel vehicle, and a hybrid vehicle, which is not limited by the present disclosure. The body 81 can further include a positioning system (not shown) and a control system (not shown). The positioning system is configured to obtain information of the autonomous driving vehicle 800 by connecting to a satellite navigation system. The control system is configured to adjust the speed and steering angle of the vehicle 800 in real time based on the position information of the target to be measured provided by the LiDAR system 100.

The vehicle 800, by incorporating the LiDAR system 100, benefits from a reduced overall volume, which in turn helps improve the vehicle's lightweight level.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A LiDAR system comprising:
a housing having an accommodating space; and
a transmitting module in the accommodating space,
wherein the housing comprises a first side plate and a top plate, the top plate is connected to and perpendicular to the first side plate, and the top plate is configured to transmit light;
the transmitting module comprises a light source module, a first light guiding module and a first scanning module, wherein
the light source module is attached to the first side plate and configured to vertically emit detection light in a direction away from the first side plate;
the first light guiding module is at a light exit side of the light source module and configured to receive and guide the detection light emitted from the light source module, such that the detection light is incident on the first scanning module; and
the first scanning module is configured to receive and project the detection light emitted from the first light guiding module, such that the detection light is directed to exit from the top plate to a target to be measured.

2. The LiDAR system of claim 1, wherein the transmitting module further comprises a collimating module;
the collimating module is at the light exit side of the light source module and between the light source module and the first light guiding module; and
the collimating module is configured to receive and converge a divergence angle of the detection light emitted from the light source module.

3. The LiDAR system of claim 2, wherein the collimating module is configured to converge the divergence angle of the detection light to a range of 10° to 20°.

4. The LiDAR system of claim 2, wherein the detection light comprises a first sub-detection light having a first polarization state and a second sub-detection light having a second polarization state;
the first polarization state is perpendicular to the second polarization state;
the first light guiding module comprises a polarization beam splitter; and
the polarization beam splitter is at a light exit side of the collimating module and configured to transmit the first sub-detection light and reflect the second sub-detection light.

5. The LiDAR system of claim 4, wherein the first light guiding module further comprises a phase delay element; and
the phase delay element is in an optical path of the second sub-detection light and configured to receive the second sub-detection light and convert the second sub-detection light into the first sub-detection light having the first polarization state.

6. The LiDAR system of claim 5, wherein the first light guiding module further comprises a first light-transmitting element;
the first light-transmitting element is attached to the top plate and in an optical path of the first sub-detection light; and
the first light-transmitting element is configured to receive the first sub-detection light emitted from the polarization beam splitter and the phase delay element, and guide the first sub-detection light to the first scanning module.

7. The LiDAR system of claim 1, wherein the housing further comprises a second side plate, the second side plate is connected to and perpendicular to the top plate, and the second side plate is opposite to the first side plate;
the LiDAR system further comprises a receiving module; and
the receiving module is the accommodating space and configured to receive the detection light reflected from the target and obtain position information of the target based on the detection light.

8. The LiDAR system of claim 7, wherein the receiving module comprises a second light guiding module and a photoelectric conversion module;
the photoelectric conversion module is attached to the second side plate, and the second light guiding module is at a side of the photoelectric conversion module close to the transmitting module; and
the second light guiding module is configured to receive and guide the detection light reflected from the target, and the photoelectric conversion module is configured to receive the detection light and obtain the position information of the target based on the detection light.

9. The LiDAR system of claim 8, wherein the receiving module further comprises a receiver lens and a second scanning module;
the receiver lens is at a light exit side of the second light guiding module and configured to receive and guide the detection light to the photoelectric conversion module; and
the second scanning module is between the second light guiding module and the receiving module and configured to receive and guide the detection light to the second light guiding module.

10. The LiDAR system of claim 7, further comprising an electronic control module in the accommodating space, wherein the electronic control module is electrically connected to the transmitting module and the receiving module; and
the electronic control module is configured to control the transmitting module to emit the detection light and to receive the position information of the target transmitted from the receiving module.

11. A vehicle comprising:
a body; and
a LiDAR system mounted on the body, the LiDAR system comprising:
a housing having an accommodating space; and
a transmitting module in the accommodating space,
wherein the housing comprises a first side plate and a top plate, the top plate is connected to and perpendicular to the first side plate, and the top plate is configured to transmit light;
the transmitting module comprises a light source module, a first light guiding module and a first scanning module, wherein
the light source module is attached to the first side plate and configured to vertically emit detection light in a direction away from the first side plate;
the first light guiding module is at a light exit side of the light source module and configured to receive and guide the detection light emitted from the light source module, such that the detection light is incident on the first scanning module, and
the first scanning module is configured to receive and project the detection light emitted from the first light guiding module, such that the detection light is directed to exit from the top plate to a target to be measured.

12. The vehicle of claim 11, wherein the transmitting module further comprises a collimating module;
the collimating module is at the light exit side of the light source module and between the light source module and the first light guiding module; and
the collimating module is configured to receive and converge a divergence angle of the detection light emitted from the light source module.

13. The vehicle of claim 12, wherein the collimating module is configured to converge the divergence angle of the detection light to a range of 10° to 20°.

14. The vehicle of claim 12, wherein the detection light comprises a first sub-detection light having a first polarization state and a second sub-detection light having a second polarization state;
the first polarization state is perpendicular to the second polarization state;
the first light guiding module comprises a polarization beam splitter; and
the polarization beam splitter is at a light exit side of the collimating module and configured to transmit the first sub-detection light and reflect the second sub-detection light.

15. The vehicle of claim 14, wherein the first light guiding module further comprises a phase delay element; and
the phase delay element is in an optical path of the second sub-detection light and configured to receive the second sub-detection light and convert the second sub-detection light into the first sub-detection light having the first polarization state.

16. The vehicle of claim 15, wherein the first light guiding module further comprises a first light-transmitting element;
the first light-transmitting element is attached to the top plate and in an optical path of the first sub-detection light; and
the first light-transmitting element is configured to receive the first sub-detection light emitted from the polarization beam splitter and the phase delay element, and guide the first sub-detection light to the first scanning module.

17. The vehicle of claim 11, wherein the housing further comprises a second side plate, the second side plate is connected to and perpendicular to the top plate, and the second side plate is opposite to the first side plate;
the LiDAR system further comprises a receiving module; and
the receiving module is the accommodating space and configured to receive the detection light reflected from the target and obtain position information of the target based on the detection light.

18. The vehicle of claim 17, wherein the receiving module comprises a second light guiding module and a photoelectric conversion module;
the photoelectric conversion module is attached to the second side plate, and the second light guiding module is at a side of the photoelectric conversion module close to the transmitting module; and
the second light guiding module is configured to receive and guide the detection light reflected from the target, and the photoelectric conversion module is configured to receive the detection light and obtain the position information of the target based on the detection light.

19. The vehicle of claim 18, wherein the receiving module further comprises a receiver lens and a second scanning module;
the receiver lens is at a light exit side of the second light guiding module and configured to receive and guide the detection light to the photoelectric conversion module; and
the second scanning module is between the second light guiding module and the receiving module and configured to receive and guide the detection light to the second light guiding module.

20. The vehicle of claim 17, wherein the LiDAR system further comprises an electronic control module in the accommodating space, the electronic control module is electrically connected to the transmitting module and the receiving module; and
the electronic control module is configured to control the transmitting module to emit the detection light and to receive the position information of the target transmitted from the receiving module.
